(19) United States
(12) Patent Application Publication
(10) Pub. No.: US 2005/0092796 A1
(43) Pub. Date: May 5, 2005

(54) Roof rack for a sport utility vehicle

(76) Inventor: Richard C. Essig, Berthoud, CO (US)

Correspondence Address: W. Scott Carson, Esq.;Dorr, Carson, Sloan, Birney & Kramer, P.C., 3010 East 6th Avenue, Denver, CO, 80206, US

(21) Appl. No.: 10/699,249

(22) Filed: Oct. 31, 2003

(51) Int. Cl. B60R 9/00

(52) U.S. Cl. 224/321

(57) ABSTRACT

A roof rack for a sport utility vehicle. The rack includes a main frame attached to the vehicle and a plurality of rack portions or cross pieces pivotally mounted to the main frame. In use, the rack portions with the gear or carrying trays supported on them can be pivoted to one side of the vehicle and out of the path of the normal movement of the vehicle top including any sunroof. The top or sun roof can then be easily and quickly moved as intended between its open and closed positions without having to unload and reload the stored gear or other items.

### BACKGROUND OF THE INVENTION

1. Field of the Invention

This invention relates to the field of roof racks for sport utility and similar vehicles and more particularly to the field of such racks that are mounted for movement relative to the vehicle.

2. Discussion of the Background. In most sport utility vehicles, carrying or storage space for gear and other items for camping, hunting, and the like is at a premium. Presently, it is common to store as much gear as possible in the rear of the vehicle and/or provide exterior racks such as roof racks to carry the gear. Current roof racks for the most part involve a main frame attached to the body of the vehicle and rack members extending across the main frame above the vehicle top. The gear or other items are then carried directly on the cross members of the rack or in trays supported on them.

In some designs, arrangements are provided so that the trays or carried items are mounted on additional members of the rack that can be slid to one side of the vehicle relative to the cross members. Normally, such sliding rack members can also be pivoted or otherwise moved downwardly relative to the cross members for ease of access to the trays or items on them. However, in these and most other arrangements, the main frame and cross members are normally intended to be permanently attached in place on the vehicle. The main frame and cross members typically cannot then be removed from their position on the vehicle without tools and without undergoing a rather time consuming and often difficult procedure. Additionally, the frame and cross members of such arrangements are designed to be positioned as close as possible to the top of the vehicle. Consequently, with the main frame and cross members permanently mounted in place and with vehicle tops (particularly soft tops) that are designed to pivot upwardly as they are opened or closed, the tops cannot be operated to move past the cross members of the rack between their open and closed positions.

Roof rack systems are available that address this problem. However, for the most part, they involve pivotally mounting the entire main frame and attached cross members to the vehicle so they can be moved as a unit out of the way to raise or lower the top. In use, the stored items or trays supported on the cross members of the main frame usually must then be removed or unloaded. Main frames in this regard are often of substantial weight by themselves and unless the gear is unloaded, the user may simply be physically unable to pivot the main frame, attached cross members, and carried items. Having to unload and re-load the items or trays every time the vehicle top is opened or closed is obviously a drawback to such pivoting systems. Additionally, the main frames are usually of considerable size and bulk and pivoting them to an out of the way position and back usually requires two or more people.

With this and other problems in mind, the present invention was developed. With it, a roof rack is provided which has a main frame attached to the vehicle and a plurality of cross pieces that are pivotally mounted to the main frame. In use, the cross pieces with the gear or carrying trays supported on them can be pivoted to one side of the vehicle and out of the path of the normal movement of the vehicle top, including any sunroof. The top or sunroof can then be easily and quickly moved as intended between its open and closed positions without having to unload and reload the stored gear or other items. Additionally, in the preferred embodiments, the roof rack of the present invention can be operated by one person.

### SUMMARY OF THE INVENTION

This invention involves a roof rack for a sport utility vehicle. The rack includes a main frame attached to the vehicle and a plurality of elongated rack portions or cross pieces pivotally mounted to the main frame. In operation, the rack portions can be positioned to extend horizontally across the vehicle above the roof line of the vehicle top to support or carry gear and other items. When desired, the rack portions can be easily and quickly pivoted to a substantially vertical position outboard of the vehicle and out of the path of movement of the vehicle top. The top (or any portion of it such as a sunroof) can then be moved as intended between its open and closed positions and the rack portions pivoted back in place to extend horizontally across the vehicle. This can all be done without having to unload any gear or other items being carried by the rack portions.

Each rack portion preferably has two, concentrically mounted members that can be slid axially relative to each other. In moving each rack portion from its horizontal position extending over the vehicle to its vertical position outboard of the vehicle, the outer of the two, concentric members can first be slid horizontally relative to the inner member toward the side of the vehicle. As the outer member approaches or reaches an outboard location, the weight of the rack portion and any load on it is then redistributed from being over the vehicle to being partially outboard of the vehicle. The rack portion in this regard is pivotally mounted to the main frame adjacent the side of the vehicle. The weight is therefore shifted from being over the vehicle and only on one side of the pivot to being partially outboard of the vehicle and more balanced on each side of the pivot. Consequently and with the weight of the rack portion and any load on it so redistributed, the operator can then easily move the pivotally mounted rack portion to its vertical position.

The roof rack of the present invention also has a simple and convenient arrangement to maintain each rack portion in its horizontal position over the vehicle and a locking mechanism to further aid in holding it in place. In an additional embodiment of the invention, a retractable member is provided to selectively engage the vehicle to hold the rack portions and attached trays in an inclined position for easier loading and unloading of the gear and other items.

### BRIEF DESCRIPTION OF THE DRAWINGS

FIG. 1 is a perspective view of the roof rack of the present invention shown in a lowered position extending across the top of the vehicle and supporting a plurality of carrying trays.

FIG. 2 is a side elevational view of the roof rack of FIG. 1.

FIG. 3 is a perspective view of the roof rack in its raised or vertical position outboard of the side of the vehicle and out of the path of movement of the vehicle top.

FIG. 4 is a side view of the roof rack in the position of FIG. 3 out of the path of movement of the vehicle top.

FIG. 5 is a view similar to FIG. 4 illustrating how the roof rack in the position of FIG. 3 is also out of the path of any moving portions of the top such as the illustrated sunroof.

FIG. 6 is a rear elevational view of the roof rack in the lowered or horizontal position of FIG. 1.

FIG. 7 illustrates the telescoping members of the rack portion of the roof rack in a position with the outer member of the pair and attached tray slid toward the outboard side of the vehicle.

FIG. 8 illustrated the telescoping members of the rack portion and attached tray being pivoted toward the upright or vertical position of FIG. 9.

FIG. 9 illustrates the rack portion and attached tray in the raised or vertical position of FIG. 3.

FIG. 10 is an enlarged view of the encircled end area of FIG. 6 illustrating how the outer member of the telescoping pair of the rack portion can be slid relative to the inner member to a position overlapping the support for the inner member.

FIG. 11 is a view taken along line 11-11 of FIG. 10.

FIG. 12 is a perspective view of the other end area of the rack portion which is pivotally mounted to the main frame.

FIG. 13 is a view taken along line 13-13 of FIG. 12 illustrating the locking mechanism which aids in maintaining the telescoping members of the rack portion in the horizontal position of FIGS. 6 and 10.

FIG. 14 is a view taken along line 14-14 of FIG. 13.

FIG. 15 is a view taken along line 15-15 of FIG. 12 showing details of the telescoping members of the rack portion and the pivotal attachment to the side member of the main frame.

FIG. 16 is a perspective view of the telescoping members of the rack portion and the attached tray in the vertical position of FIG. 9.

FIG. 17 is a perspective view of an extendable prop mechanism which abuts the vehicle to hold the two rack portions and attached tray at an inclined angle for easier access to the tray for loading and unloading gear.

### DETAILED DESCRIPTION OF THE INVENTION

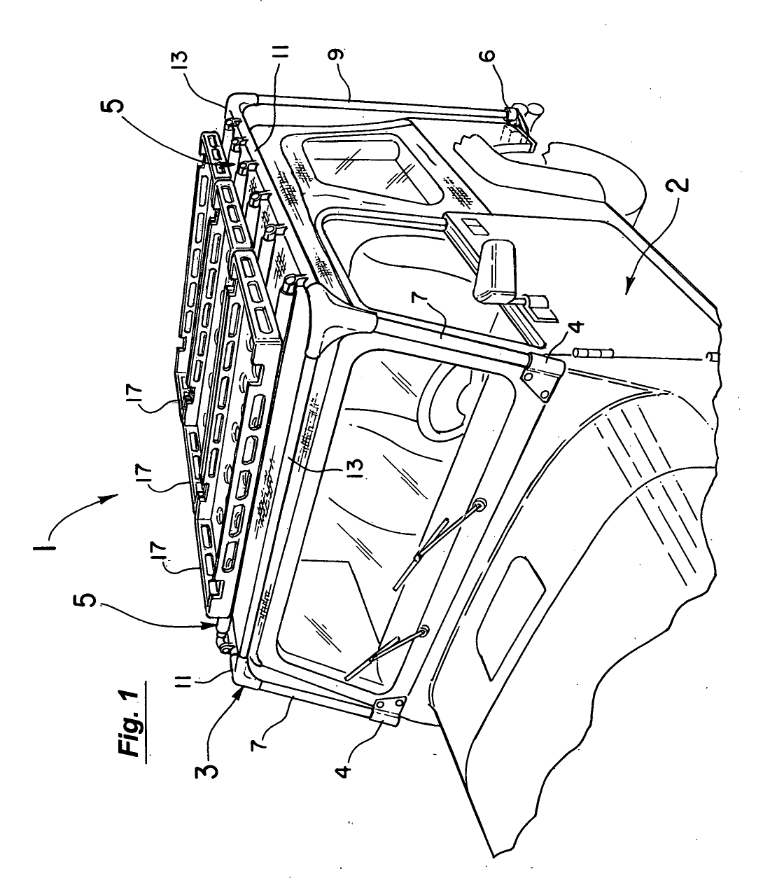

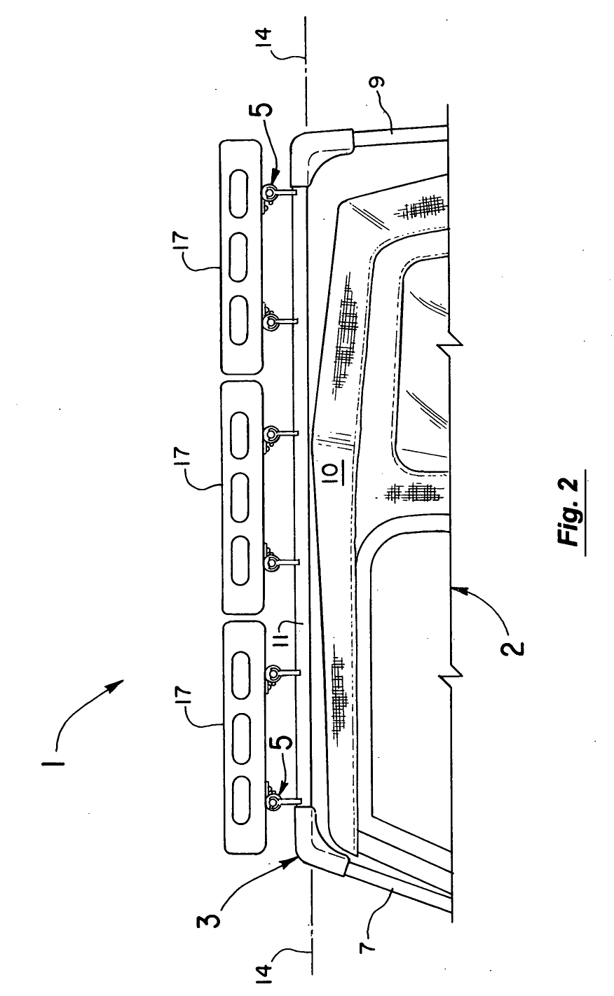

As shown in FIGS. 1 and 2, the present invention includes a roof rack 1 for a vehicle 2. The roof rack 1 preferably has a main frame 3 mounted to the vehicle 2 and a plurality of elongated rack portions 5 extending across the top of the vehicle 2. The main frame 3 can be secured to the vehicle 2 in any number of ways. However, in the illustrated manner of FIGS. 1 and 2, the main frame 3 has a pair of vertically extending front and rear members 7 and 9 (see FIG. 1). The front members 7 in this regard can be fixedly attached to the vehicle 2 adjacent the base of the windshield by brackets 4. Similarly, the rear members 9 can be fixedly attached adjacent the rear 6 of the body of the vehicle 2. Substantially horizontal side members 11 and cross members 13 then extend between the vertical members 7 and 9 as shown creating the overall shape of the main frame 3. The rack portions 5 are movable as explained below but in the position of FIGS. 1 and 2, each elongated rack portion 5 extends substantially horizontally between the side members 11 of the main frame 3.

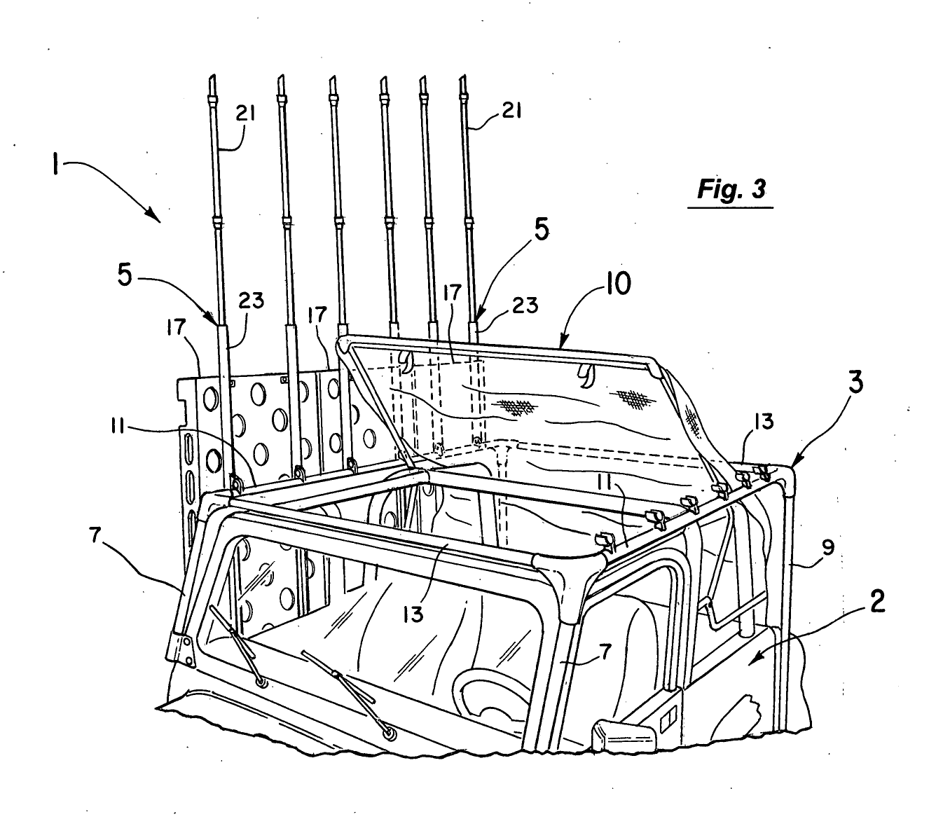

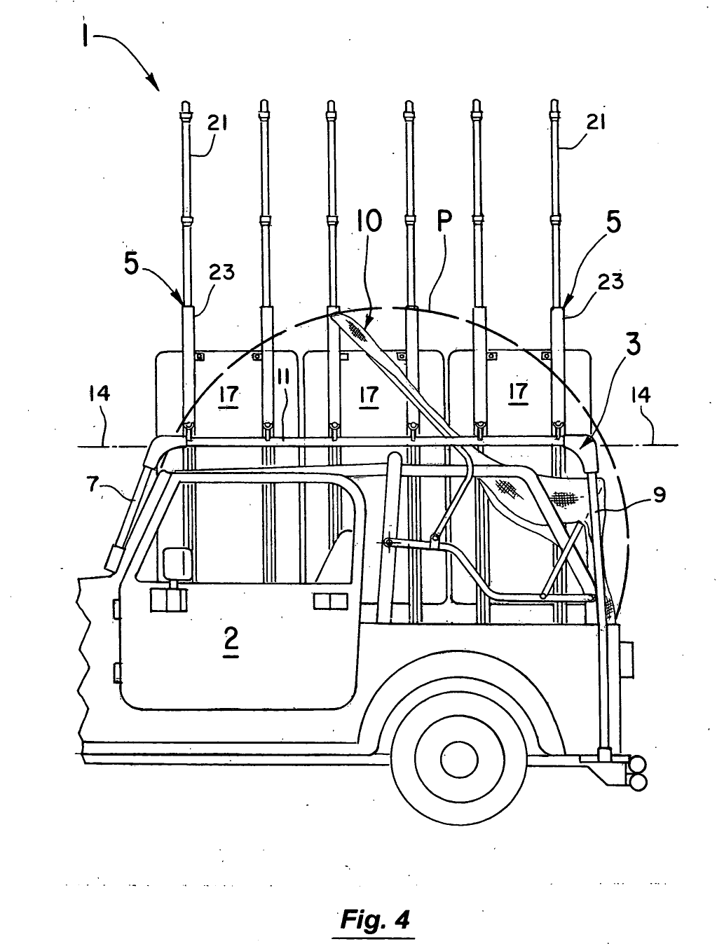

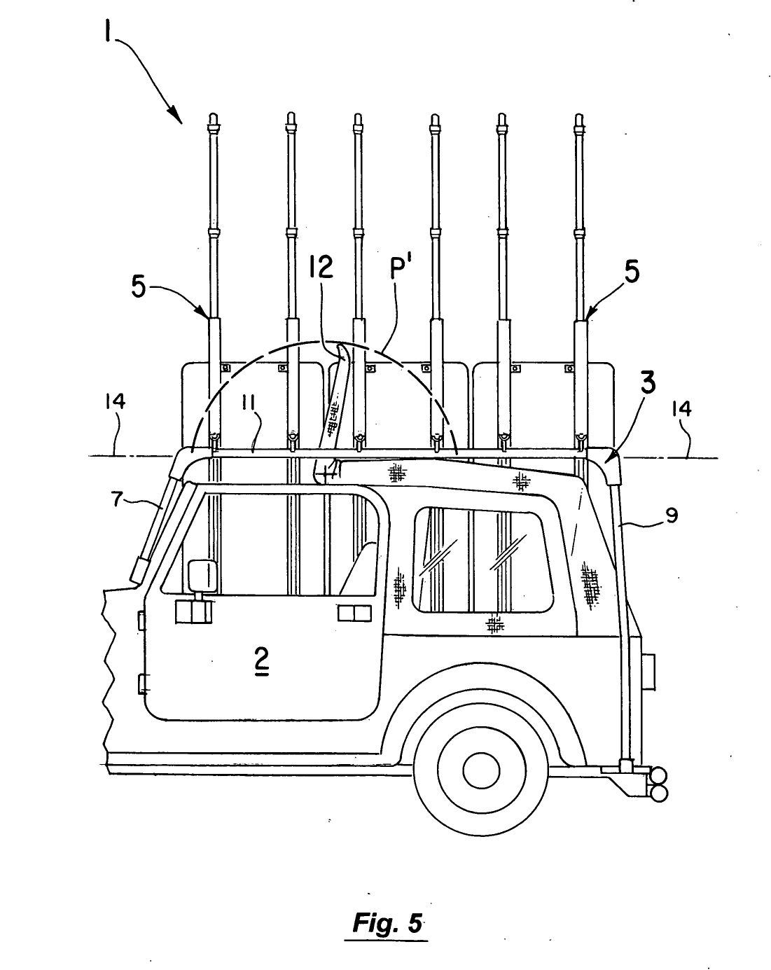

In the position of FIGS. 1 and 2, items such as skis, canoes, or other gear can be supported directly on the elongated rack portions 5 if desired. However, in the illustrated version of FIGS. 1 and 2, trays 17 or other storage containers more suitable for carrying smaller items are shown conveniently mounted on pairs of the elongated rack portions 5. Each rack portion 5 in this regard as illustrated in FIGS. 1 and 2 extends across the vehicle 2 above the roof line of the closed top 10 (see FIG. 2). In operation as explained in more detail below, each rack portion 5 is mounted to the main frame 3 for pivotal movement between the substantially horizontal position of FIG. 1 and the substantially vertical position of FIG. 3. In the position of FIG. 3, the rack portions 5 are moved out of the path of the movement of the vehicle top 10. Consequently, the vehicle top 10 (see FIG. 4) or any portion of the top 10 such as the sunroof 12 (FIG. 5) can be opened or closed as desired.

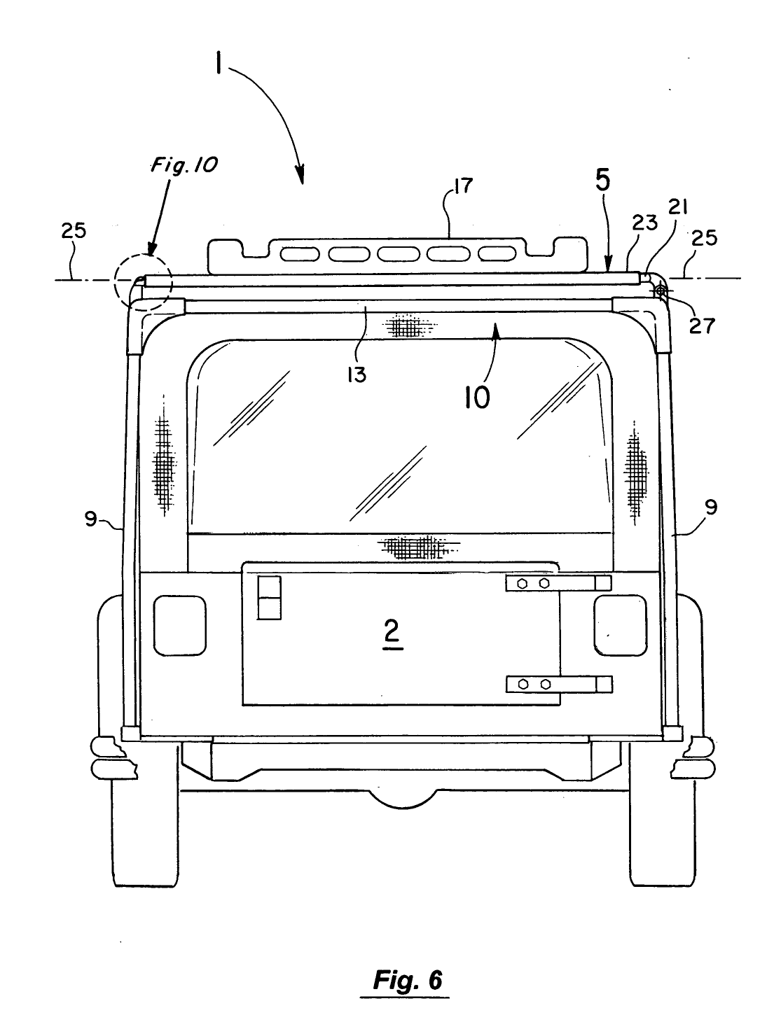

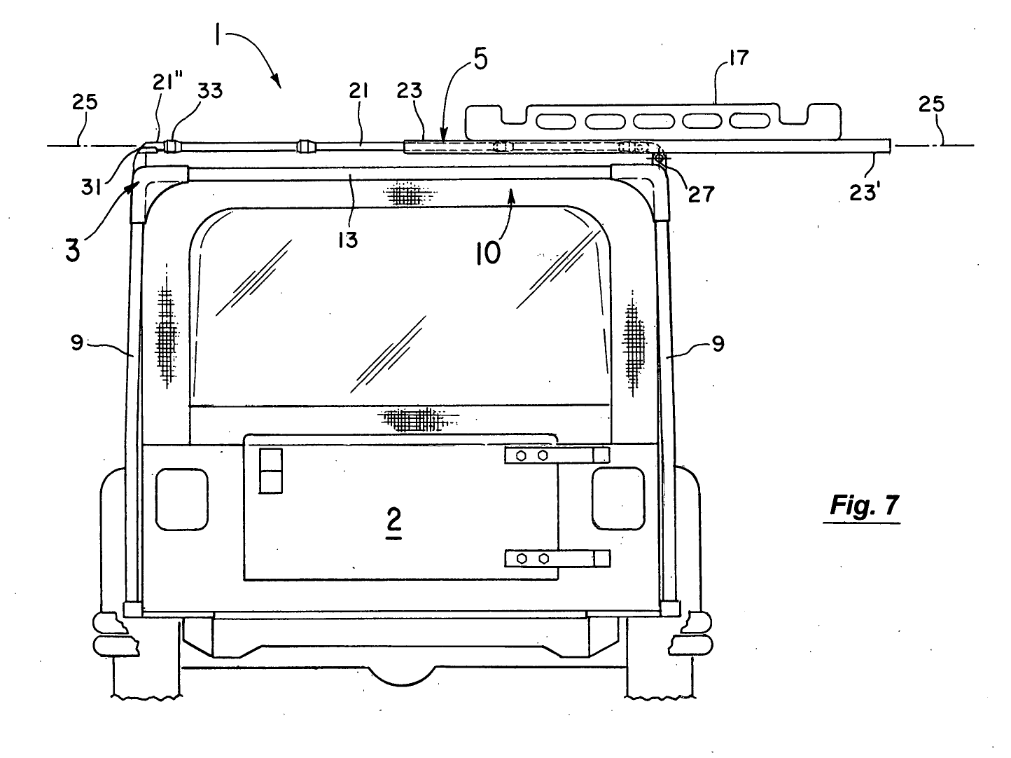

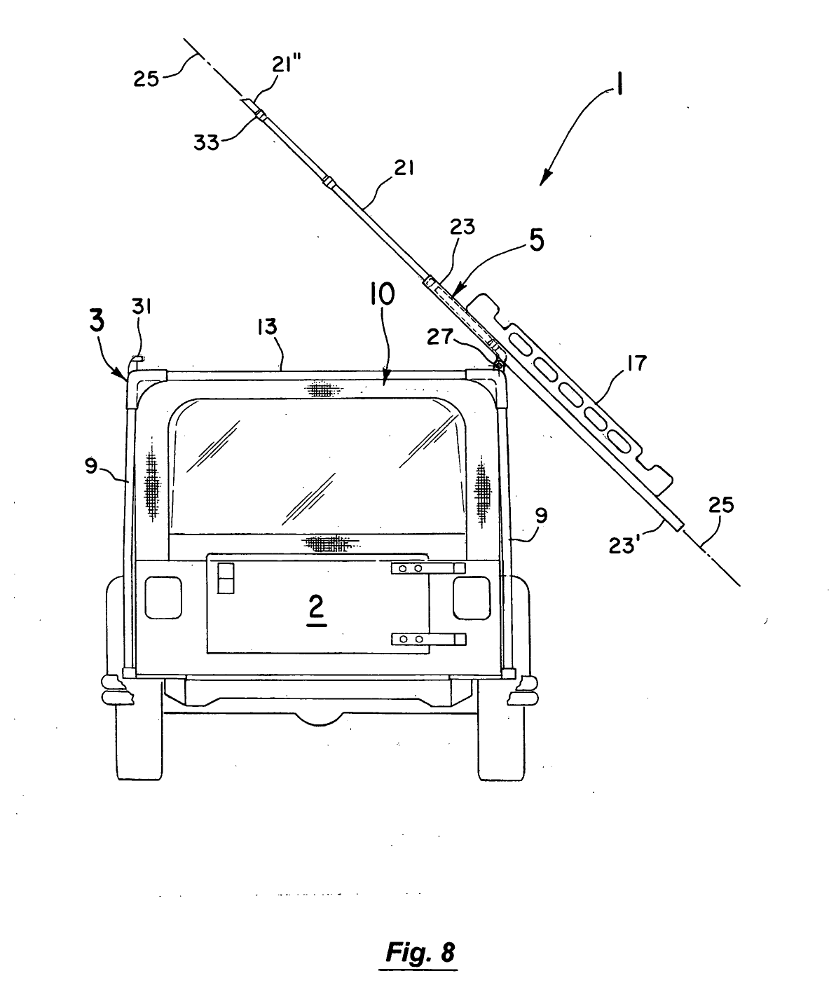

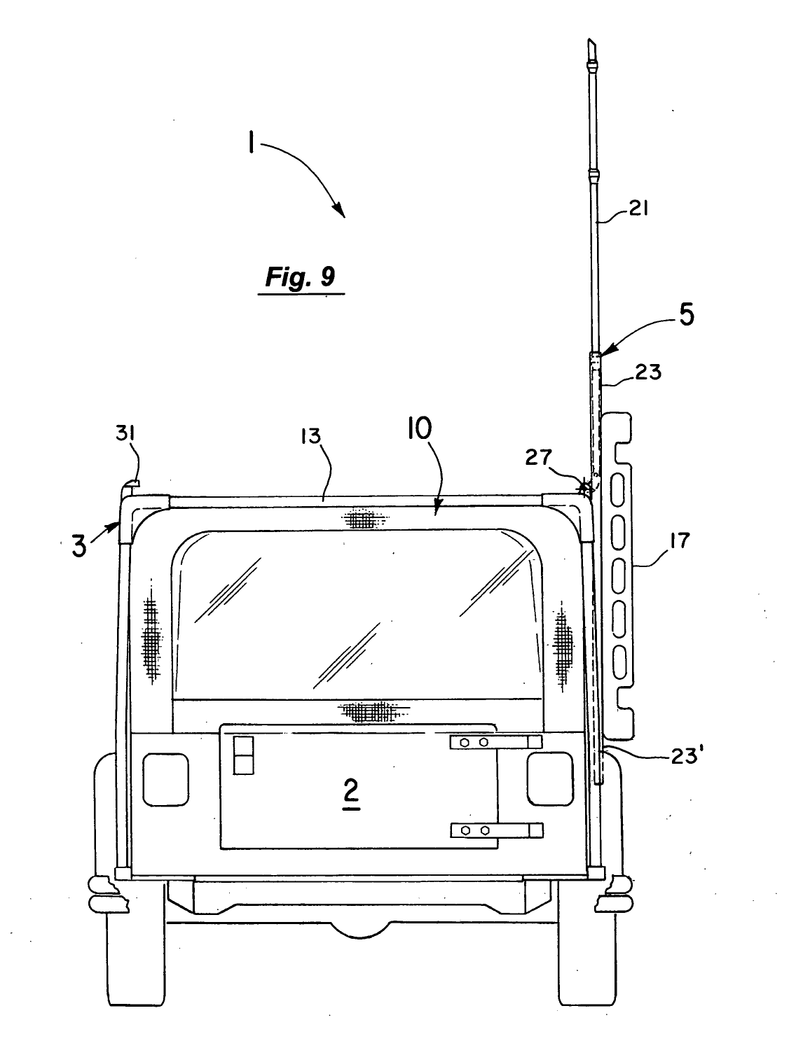

In the preferred embodiment, each rack portion or cross piece 5 as best seen in FIGS. 3, 6, and 7 has first and second, concentric members 21 and 23. The members 21 and 23 are preferably mounted for sliding movement relative to each other along the axis 25 (see FIGS. 6 and 7). In use and in moving each rack portion 5 from the horizontal position of FIGS. 1 and 6 to the substantially vertical position of FIGS. 3 and 9, the member 23 in FIG. 6 can be first pulled or slid toward the outboard side of the vehicle 2 (from the location of FIG. 6 to the location of FIG. 7). In the position of FIG. 7, at least a part of the member 23 is located outboard of the vehicle 2. Once in the position of FIG. 7 or as the member 23 and attached tray 17 are being manually slid to the right from FIG. 6 to FIG. 7, the outboard end 23′ of member 23 (see FIG. 7) can be pulled downwardly. This will then pivot the members 21 and 23 of each rack portion 5 and the attached tray 17 (FIG. 8) about the substantially horizontal axis 27. The pivotal axis 27 in this regard is substantially perpendicular to the sliding axis 25 of member 21,23. Continuing pivotal movement will thereafter move the rack portion or cross piece 5 and attached tray 17 to a substantially vertical position (FIG. 9). In the position of FIG. 9, the rack portion 5 and attached tray 17 are preferably outboard of the side of the vehicle 2 and out of the movement path P (see FIG. 4) of the vehicle top 10. If the vehicle top 10 has a movable portion such as the sunroof 12 of FIG. 5, the rack portion 5 and attached tray 17 in the position of FIG. 9 are also out of its movement path P′. Additionally, in the position of FIG. 9, the trays 17 are more accessible for loading and unloading gear.

The driver and passengers of the vehicle 2 can thus store or mount whatever items they wish directly on the rack portions 5 or in the illustrated trays 17 yet still be able to open and close the vehicle top 10 or sunroof 12. The top 10 or sunroof 12 in the closed position of FIGS. 1 and 2 then covers the interior of the vehicle 2 protecting the interior as well as the driver and passengers from the elements. However, when desired, the top 10 or sunroof 12 can be moved to an open position uncovering the interior of the vehicle 2 (or at least a part of the interior in the case of the sunroof 12) so the driver and passengers can enjoy an open air experience. In doing so as explained above, the rack portions or cross pieces 5 in the horizontal position of FIGS. 1, 2, and 6 are preferably mounted close to but still above the roof line of the closed top 10. The roof line of the closed top 10 in this regard extends below the horizontal reference plane 14 of FIG. 2. In this position of FIGS. 1 and 2 as also discussed above, the rack portions 5 are in the movement path P of the vehicle top 10 (FIG. 4) as well as the path P′ of the sunroof 12 of FIG. 5. These paths P and P′ each extend above the horizontal reference plane 14 as illustrated. Nevertheless, with the capability of the rack portions 5 of the present invention to be pivoted out of the respective paths P and P′, the full top 10 and/or a portion of it such as the sunroof 12 can be raised or lowered in the normally intended fashion. Further, this can be done without having to unload the items from the rack portions 5 or attached trays 17. The driver and passengers then have the convenience and advantage of overhead storage capability for their travels but without hindering the use of their top 10 or sunroof 12 to enjoy the open air experience.

The operation of the sliding, concentric members 21 and 23 of each rack portion 5 in FIGS. 6-9 makes the movement of the rack portions 5 very easy for a single person to handle. More specifically and in first sliding the outer member 23 of each rack portion 5 from the position of FIG. 6 toward the position of FIG. 7, the weight of the members 21,23 and any load thereon is changed from being totally to the left of the pivot 27 (FIG. 6) to being partially distributed on each side of the pivot 27 (FIG. 7). The pivot 27 then acts in the manner of a center pivot wherein the telescoping members 21,23 (whether or not member 23 is loaded with trays or gear) can be easily controlled and moved to the positions of FIGS. 8 and 9. This can normally be done by a single person gripping and manipulating the end segment 23′ of member 23 and/or the outboard side of the tray 17 in FIGS. 8 and 9. In many cases and depending upon the load distribution on the member 23, the weight transfer to the right of the pivot 27 between FIGS. 6 and 7 may well bias the telescoping members 21, 23 to begin pivoting away from the horizontal. In any event and even without such biasing, the weight transfer in the position of FIG. 7 normally enables the user to easily control and complete the movement of the members 21,23 to the vertical position of FIG. 9.

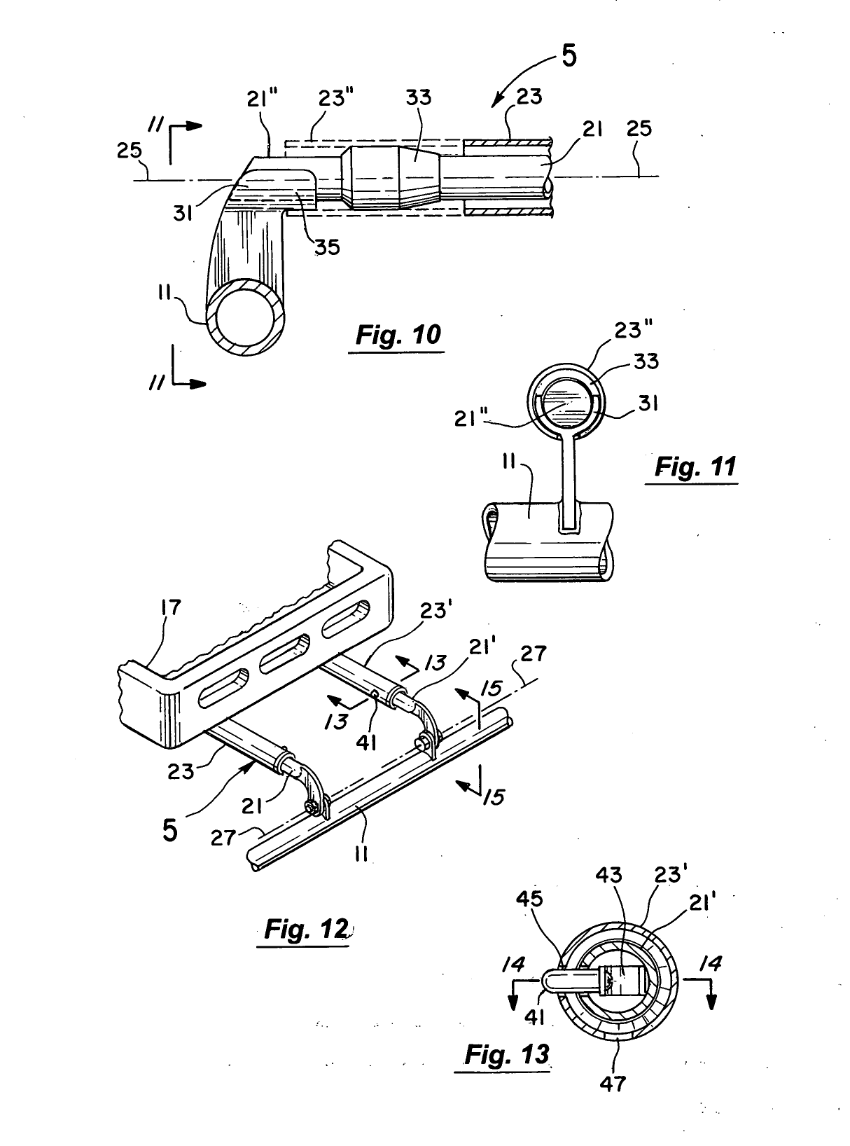

FIGS. 10-16 illustrate details of the preferred embodiment of the present invention and its operation. In FIGS. 10 and 11, it is shown how each rack portion 5 is positioned horizontally and maintained firmly in place. That is and in reversing the raising movement of FIGS. 6-9 to lower the rack portion 5 in place over the top 10, the free end 21″ of the inner, concentric member 21 at the stage of FIG. 7 is received and supported in the upwardly open, cup-like member 31 (see also FIGS. 10 and 11). To then aid in maintaining the member 21 in this position, the outer, concentric member 23 (see again FIGS. 7 and 10) is first slid to the left in FIG. 7 to the position shown in solid lines in FIG. 10. Continued movement of the outer, telescoping member 23 along the axis 25 as guided by the beveled bushing 33 to the position shown in dotted lines in FIG. 10 will then overlap the end segment 23″ of member 23 and the lip 35 of the support member 31. The support member 31 in this regard extends upwardly from the side member 11 of the main frame 3. In the dotted position of FIG. 10, the members 21, 23 of the rack portion 5 are thus held firmly in place.

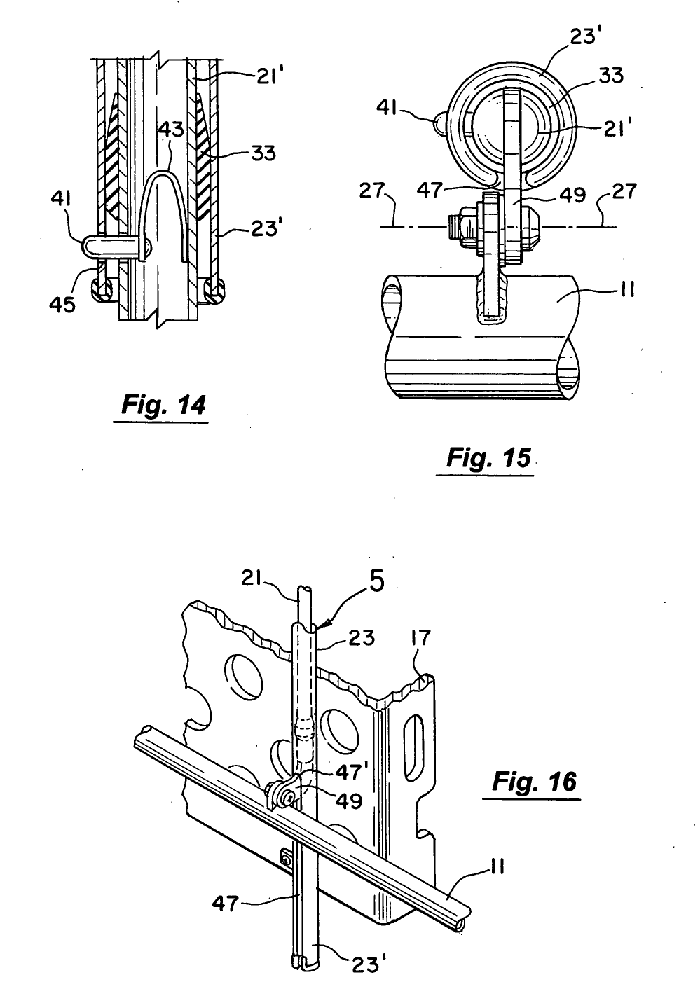

To further aid in maintaining the members 23″ and 35 in the overlapping position of FIG. 10, a locking mechanism (see FIGS. 12-14) is provided on the other end segments 21′, 23′ of the telescoping members 21, 23 to releasably secure them together. The locking mechanism can be of any design. However, in the illustrated one of FIGS. 13-14, the locking mechanism includes a simple button member 41 biased by spring 43 mounted in the inner member 21′. In operation, the depressible button 41 is selectively receivable in the hole 45 in the outer member 23′. Preferably, the location of the hole 45 along the outer member 23′ and the engagement by the button 41 in the hole 45 corresponds with the far end segments 21″,23″ being in the extended position of FIG. 10.

In FIGS. 12, 15, and 16, further details of the telescoping members 21, 23 of each rack portion 5 are illustrated. As shown, the inner member 21 at the end segment 21′ is pivotally mounted to the horizontal, side member 11 of the main frame 3 (FIG. 12) for movement about the horizontal axis 27 (FIG. 15). Additionally, the outer member 23 is slotted at 47 (see FIGS. 15 and 16) so member 23 can be slidably moved over and along member 21 between the positions of FIGS. 6 and 7. The closed end 47′ of the slot 47 in FIG. 16 (or a cross piece if the slot 47 runs the entire length of the member 23) will then abut the flange 49 of the pivot to stop the relative sliding movement of members 21, 23 in the fully extended position of FIG. 9.

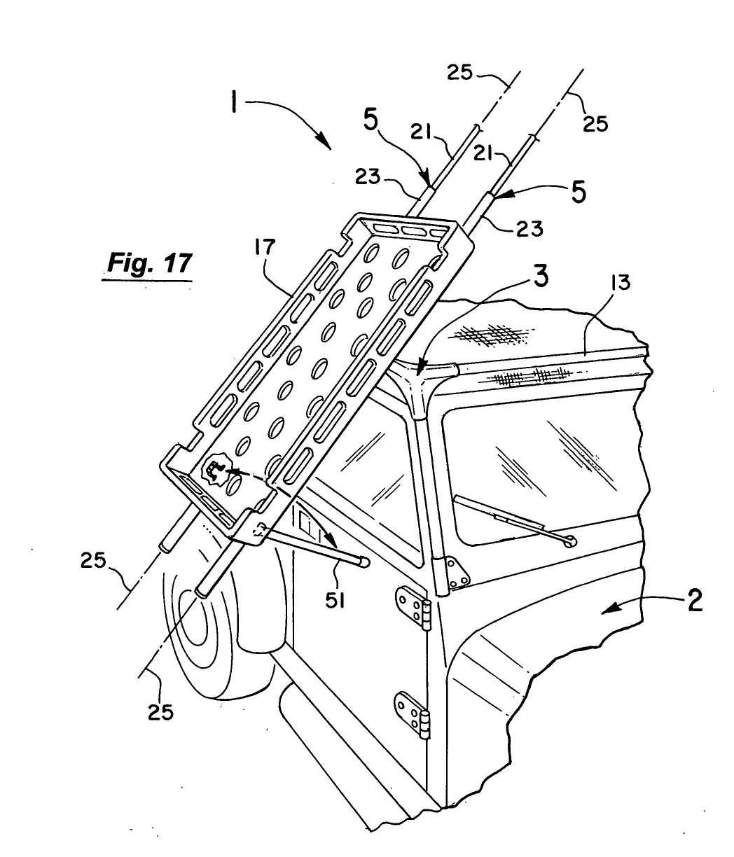

Although each rack portion 5 has been shown in FIGS. 3 and 9 as being moved to a substantially vertical position, one or more of the rack portions 5 could be inclined to the vertical as in FIG. 17 for easier loading and unloading of the gear. To hold the rack portions 5 and attached tray 17 in the inclined position of FIG. 17, a prop mechanism is provided including member 51. The member 51 as illustrated in FIG. 17 can be pivoted from a retracted position extending substantially between the pair of rack members 5 underneath the tray 17 to an extended position engaging or abutting the vehicle 2. The rack portions 5 and attached tray 17 can then be supported at a predetermined, inclined angle (e.g., 30 degrees) to the vertical to facilitate loading and unloading gear or other items on the rack portions 5 or in the tray 17. In the position of FIG. 17, the members 21, 23 may still be clear of the movement paths P and P′ of the top 10 and sunroof 12. However, if needed, the member 51 can be retracted so the members 21, 23 can still be moved out of the way (e.g., to the vertical position of FIGS. 3 and 9) to pass the top 10 or sunroof 12. In the vertical position of FIGS. 3 and 9, the weight distribution of the rack portions 5 with or without the trays 17 or any gear will serve to hold the rack portions in the vertical position. Similarly, the weight distribution in the inclined position of FIG. 17 will bias the rack portions 5 toward the vertical position of FIGS. 3 and 9.

In the preferred embodiments, pairs of rack portions 5 extending along substantially parallel axes 25 are shown in use with an attached tray 17 wherein the pairs 5 and tray 17 are then moved in unison. However, gear and other items (e.g., skis, canoes) as mentioned above could be supported directly on one or more of the rack portions 5. Additionally, as many or as few of the rack portions 5 as desired could be joined to move in unison with the space between adjacent portions 5 partially or completely filled. Alternatively, each individual rack portion 5 could be independently operated if desired. In this regard, the illustrated embodiment of pairs of rack portions 5 with attached trays 17 is only an example of a convenient way to carry gear that can be easily manipulated by one person. It is also noted that the rack portions 5 are shown as being pivoted to the passenger side of the vehicle 2 but could be mounted in a mirror fashion to pivot to the driver's side if desired. In the illustrated embodiments, the main frame 3 is preferably attached to the vehicle 2 in a fixed manner as it is only necessary to move the rack portions 5 to raise or lower the top 10 or sunroof 12. However, the main frame 3 could be mounted to the vehicle 2 is a movable manner if desired or at least in a less permanent manner than illustrated. It is also noted that the preferred embodiments are primarily intended for use with full or partial soft tops but they can also accommodate full or partial hardtops. This would include hardtops that move or operate essentially in the manner of the illustrated soft tops as well as ones that could be removed by sliding them rearwardly past the rear members 9 and 13 of the main frame 3.

While several embodiments of the present invention have been shown and described in detail, it to be understood that various changes and modifications could be made without departing from the scope of the invention.

1. A roof rack for a vehicle, said vehicle having a top with at least a portion of the top mounted for movement between a closed position covering the interior of the vehicle and an open position uncovering at least part of the interior of the vehicle, said top with said movable portion in said closed position having a roof line extending below a horizontal plane, said top portion in being moved between said closed and open positions passing along a path extending above said horizontal plane,
said roof rack having a main frame attached to the vehicle and a rack portion mounted to said main frame for movement relative thereto between a first position extending substantially across the vehicle above the roof line of the vehicle top in the path of movement of said top portion and a second position extending out of the path of movement of said top portion wherein said top portion with said rack portion in said second position can be moved along said path above said horizontal plane between said closed and open positions.

2. The roof rack of claim 1 wherein said rack portion is pivotally mounted to said main frame for movement relative thereto about a pivotal axis.

3. The roof rack of claim 2 wherein said pivotal axis is substantially horizontal.

4. The roof rack of claim 3 wherein said rack portion has first and second members slidably mounted to each other for movement relative to each other along an axis substantially perpendicular to said pivotal axis.

5. The roof rack of claim 1 wherein said rack portion has first and second members slidably mounted to each other for movement relative to each other along a sliding axis.

6. The roof rack of claim 5 wherein the first member of said rack portion is pivotally mounted to said main frame for movement relative thereto about a pivotal axis between a position extending substantially horizontally across the vehicle above the roof line of the vehicle top in the path of movement of said top portion and a position spaced therefrom about said pivotal axis.

7. The roof rack of claim 6 wherein the second member of said rack portion with said first member in said horizontal position across the vehicle is slidably movable along said sliding axis relative to the first member between a location extending substantially across the vehicle and a location with at least part of said second member substantially outboard of a side of the vehicle.

8. The roof rack of claim 7 wherein said rack portion with said second member in said outboard location is pivotally movable about said pivotal axis to move said rack portion including said first and second members to a substantially vertical position.

9. The roof rack of claim 7 wherein said main frame includes an upwardly open member to removably receive an end segment of said first member of said rack portion with said first member in said horizontal position and wherein said second member includes an end segment thereof overlapping said upwardly open member along said sliding axis to maintain said first member in said horizontal position.

10. The roof rack of claim 5 wherein said first and second members of said rack portion are concentrically mounted to each other about said sliding axis.

11. The roof rack of claim 5 further including a locking mechanism to releasably secure said second member to said first member with said first member in said horizontal position.

12. The roof rack of claim 1 wherein said rack portion is pivotally mounted to said main frame for movement relative thereto about a substantially horizontal axis between said first and second positions.

13. The roof rack of claim 1 wherein said rack portion extends substantially horizontally in said first position and substantially vertically in said second position and said roof rack further includes a mechanism selectively positionable to support said rack portion in an inclined position between said first and second positions with said rack portion at an inclined angle to the vertical.

14. The roof rack of claim 13 wherein said mechanism includes a member mounted to said rack portion and movable between a retraced position and an extended position, said member in said extended position engaging the vehicle to hold said rack portion in said inclined position.

15. The roof rack of claim 1 wherein said rack portion includes at least a pair of spaced-apart, elongated members respectively extending along substantially parallel axes.

16. The roof rack of claim 15 further including at least one tray supported on said pair of elongated members.

17. A method for operating a roof rack on a vehicle having a top with at least a portion of the top mounted for movement between a closed position covering the interior of the vehicle and an open position uncovering at least part of the interior of the vehicle, the top with said movable portion in said closed position having a roof line extending below a horizontal plane, said top portion in being moved between said closed and open positions passing along a path extending above said horizontal plane, the method comprising the steps of:
(a) attaching a main frame of the roof rack to the vehicle,
(b) mounting a rack portion to said main frame for movement relative thereto between a first position extending substantially across the vehicle above the roof line of the vehicle top in the path of movement of said top portion and a second position extending out of the path of movement of said top portion,
(c) moving said rack portion from said first to said second position, and
(d) moving said top portion with said rack portion in said second position along said path above said horizontal plane to one of said closed and open positions.

18. The method of claim 17 further including the step of:
(e) moving said rack portion from said second position to said first position with said top portion in said one of said closed and open positions.

19. The method of claim 17 further including the limitations of extending the rack portion substantially horizontally in said first position and substantially vertically in said second position and selectively supporting the rack portion in a position inclined to the vertical between said first and second positions.
